(19) United States
(12) Patent Application Publication
(10) Pub. No.: US 2026/0238051 A1
(43) Pub. Date: Aug. 13, 2026

(54) MAGNET WIRE EMBEDDED PCB STATOR AND AXIAL FLUX MOTOR INCLUDING THE SAME

(71) Applicant: GACHON UNIVERSITY OF INDUSTRY-ACADEMIC COOPERATION FOUNDATION, Seongnam-si (KR)

(72) Inventors: Do-Hyeon CHOI, Seongnam-si (KR); Won-Ho KIM, Hwaseong-si (KR); Min-Ki HONG, Seoul (KR); Hyung-Sub HAN, Seoul (KR); Seung Hoon KO, Namyangju-si (KR)

(21) Appl. No.: 19/326,416

(22) Filed: Sep. 11, 2025

(30) Foreign Application Priority Data
Jan. 15, 2025 (KR) 10-2025-0006184

(51) Int. Cl. H02K 1/18; H02K 1/02; H02K 1/14; H02K 1/2795; H02K 3/52

(52) U.S. Cl. CPC H02K 1/182; H02K 1/02; H02K 1/146; H02K 1/2795; H02K 3/522; H02K 2211/03

(57) ABSTRACT

The present disclosure relates to a magnet wire embedded PCB stator and an axial flux motor including the same, and more particularly, to a magnet wire embedded PCB stator that increases counter electromotive force by embedding a winding or a magnetic core in a PCB stator, and an axial flux motor including the same. An object of the present disclosure is to increase the counter electromotive force of an axial flux motor including a PCB stator by embedding a conventional tooth configuration in a PCB stator.

### CROSS-REFERENCE TO RELATED APPLICATIONS

This application claims priority under 35 U.S.C. § 119 to Korean Patent Application No. 10-2025-0006184, filed on Jan. 15, 2025, in the Korean Intellectual Property Office, the disclosure of which is incorporated herein by reference in its entirety.

### TECHNICAL FIELD

The following disclosure relates to a magnet wire embedded PCB stator and an axial flux motor including the same, and more particularly, to a magnet wire embedded PCB stator that increases counter electromotive force by embedding a winding or a magnetic core in a PCB stator, and an axial flux motor including the same.

### BACKGROUND

An axial flux motor is a motor in which magnetic poles of a stator and permanent magnets of a rotor are arranged facing each other in a direction parallel to a rotational axis. The axial flux motor has the advantage of being compact while also capable of high output, which is used in various fields for a wide range of applications.

Typically, the axial flux motor is configured to include a toroidal rotor and a stator, which are arranged facing each other with respect to the rotational axis. As the rotor, a toroidal rotor equipped with a permanent magnet and a magnetic material is mainly used. The stator is configured in the form of a toroidal magnetic plate formed with a plurality of teeth spaced apart from each other in a circumferential direction, and has coils wound in the spaces between the teeth to induce electromagnetic force.

In recent years, with the development of printed circuit board (PCB) technology, it is also possible to manufacture a coreless type stator. The coreless type stator is manufactured by printing coils on the printed circuit board (PCB) without winding the coils on teeth, thereby reducing a thickness of the stator. In addition, slotless axial flux motors using PCBs as stators, which generate flux through conductor patterns without printing coils, are also being developed.

However, these PCB stator-based axial flux motors lack teeth, resulting in lower flux than the conventional axial flux motors with teeth.

### SUMMARY

The present disclosure is directed to increasing counter electromotive force of an axial flux motor including a PCB stator by embedding the conventional teeth configuration into a PCB stator.

In one general aspect, a printed circuit board (PCB) stator for an axial flux motor includes: a substrate that has an annular shape, and has a plurality of conductor patterns and a plurality of insertion grooves formed thereon; and a core unit that is inserted into the insertion groove, in which the plurality of conductor patterns are formed to be spaced apart from each other at a predetermined interval in a circumferential direction of the substrate, and the insertion groove are formed between the respective conductor patterns.

The core unit may include at least one of a winding and a magnetic core.

The winding may be applied with an independent power supply different from a power supply applied to the substrate.

The core unit may include the magnetic core, and may be inserted into the substrate with epoxy applied to an outer wall of the magnetic core, and fixed by bringing the epoxy into contact with the outer wall of the insertion groove of the substrate.

The core unit may include a winding and a magnetic core, and the winding may be wound around an outer wall of the magnetic core and inserted into the substrate.

In another general aspect, an axial flux motor includes: a printed circuit board (PCB) stator for an axial flux motor including a substrate that has an annular shape, and has a plurality of conductor patterns and a plurality of insertion grooves formed thereon and a core unit that is inserted into the insertion groove, the plurality of conductor patterns being formed to be spaced apart from each other at a predetermined interval in a circumferential direction of the substrate, and the insertion groove being formed between the respective conductor patterns; a stator back yoke that is attached to one side of the PCB stator; and a rotor that includes a plurality of permanent magnets, and is positioned on the other side of the PCB stator to rotate by flux generated by the PCB stator.

The stator back yoke may include at least one lead hole through which a lead wire of a winding inserted into the PCB stator passes.

The stator back yoke may include a soft magnetic material.

The soft magnetic material may include at least one of a silicon steel sheet, a laminated magnetic core, ferrite, an amorphous metal, and a soft magnetic composite (SMC).

The stator back yoke may include a rolled core formed by rolling an electrical steel sheet of a soft magnetic material.

The stator back yoke may have a structure in which at least one electrical steel sheet of a soft magnetic material is laminated.

### BRIEF DESCRIPTION OF THE DRAWINGS

FIG. 1 is an exploded perspective view illustrating a PCB stator according to an embodiment of the present disclosure.

FIG. 2 is a front view illustrating the PCB stator according to an embodiment of the present disclosure.

FIG. 3 is a rear view illustrating the PCB stator according to an embodiment of the present disclosure.

FIG. 4 is an exploded perspective view illustrating an axial flux motor according to an embodiment of the present disclosure.

FIGS. 5 and 6 are cross-sectional perspective views illustrating a stator back yoke of the axial flux motor according to an embodiment of the present disclosure.

### DETAILED DESCRIPTION OF MAIN ELEMENTS

100: PCB stator
110: Substrate
111: Conductor pattern
112: Insertion groove
120: Core unit
121: Winding
122: Magnetic core
200: Stator back yoke
210: Lead hole
300: Rotor

### DETAILED DESCRIPTION OF EMBODIMENTS

The above-described objects, features, and advantages of the present disclosure will become more obvious from the following detailed description provided in relation to the accompanying drawings. The following specific structural or functional descriptions are only exemplified for the purpose of explaining the embodiments according to the concept of the present disclosure, and the embodiments according to the concept of the present disclosure may be implemented in various forms and should not be construed as limited to the embodiments described herein or in the application. Since embodiments according to the concept of the present disclosure may be variously modified and may have several forms, specific embodiments will be illustrated in the accompanying drawings and will be described in detail in the present specification or application. However, it is to be understood that the present disclosure is not limited to specific embodiments, but includes all modifications, equivalents, and substitutions falling in the spirit and the scope of the present disclosure. Terms such as ‘first’, ‘second’, or the like, may be used to describe various components, but these components are not to be construed as being limited to these terms. The terms are used only to distinguish one component from another component. For example, a first component may be named a second component and the second component may also be named the first component, without departing from the scope of the present disclosure. It is to be understood that when one component is referred to as being connected to or coupled to another component, it may be connected directly to or coupled directly to another component or be connected to or coupled to another component with the other component interposed therebetween. On the other hand, it is to be understood that when one component is referred to as being connected directly to or coupled directly to another component, it may be connected to or coupled to another component without the other component interposed therebetween. Other expressions for describing the relationship between components, such as between and immediately between or adjacent to and directly adjacent to, etc., should be interpreted similarly. Terms used in the present specification are used only in order to describe specific embodiments rather than limiting the present disclosure. Singular expressions are intended to include plural expressions unless the context clearly indicates otherwise. It is to be understood that terms “include,” “have,” or the like, used in the present specification specify the presence of features, numerals, steps, operations, components, parts, or a combination thereof described in the present specification, but do not preclude the presence or addition of one or more other features, numerals, steps, operations, components, parts, or a combination thereof. Unless indicated otherwise, it is to be understood that all the terms used in the specification including technical and scientific terms have the same meaning as those that are generally understood by those who skilled in the art. Terms generally used and defined in a dictionary are to be interpreted as the same meanings with meanings within the context of the related art, and are not to be interpreted as ideal or excessively formal meanings unless clearly indicated in the present specification. Hereinafter, exemplary embodiments of the present disclosure will be described in detail with reference to the accompanying drawings. Throughout the accompanying drawings, the same reference numerals indicate the same members.

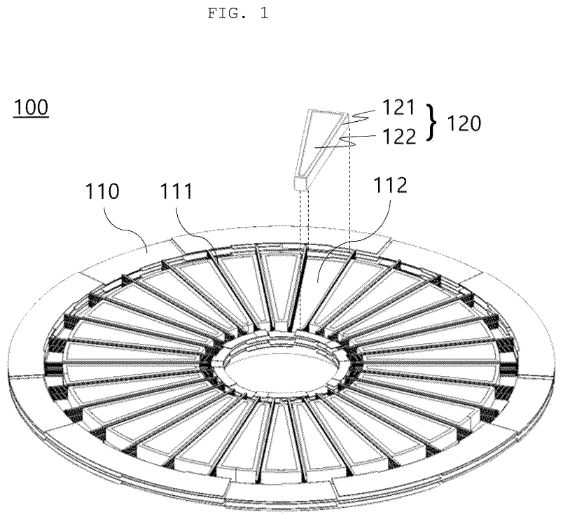

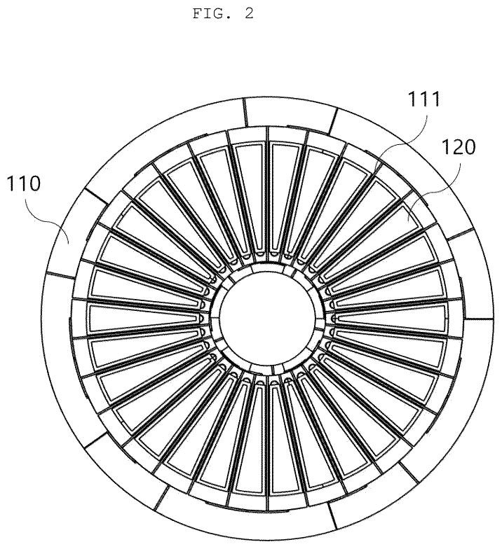

FIG. 1 is an exploded perspective view illustrating a printed circuit board (PCB) stator according to an embodiment of the present disclosure, and FIG. 2 is a front view illustrating the PCB stator according to an embodiment of the present disclosure.

Referring to FIGS. 1 and 2, a PCB stator 100 for an axial flux motor according to an embodiment of the present disclosure may include a substrate 110 and a core unit 120.

The substrate 110 has an annular shape, and may be formed with a plurality of conductor patterns 111 and a plurality of insertion grooves 112. The plurality of conductor patterns 111 formed on the substrate 110 may be spaced apart from each other by a predetermined interval in a circumferential direction of the substrate 110. The insertion grooves 112 may be formed between each of the conductor patterns 111. The plurality of conductor patterns 111 formed on the substrate 110 may be arranged side by side along a circumferential direction of the substrate 110 in a linear form extending from an outer peripheral surface of the substrate 110 toward its central axis. The substrate 110 may be electrically connected to an external power supply to generate flux through the plurality of conductor patterns 111, thereby functioning as the stator of the axial flux motor.

The core unit 120 may be inserted into the insertion groove 112 formed on the substrate 110. That is, the core unit 120 may be inserted between the respective conductor patterns 111 of the substrate 110. The core unit 120 may be configured to include at least one of a winding 121 and a magnetic core 122, similar to a slot-type tooth. However, the core unit 120 according to the present disclosure is inserted into the substrate 110 where flux is formed by the conductor pattern 111, and may be composed of only the magnetic core 122 without including the winding 121. The core unit 120 inserted into the insertion groove 112 of the substrate 110 may be applied with an independent power supply different from the power supply supplied to the substrate 110.

In addition, when the core unit 120 is composed of only the magnetic core 122 without the winding 121, the core unit 120 may be inserted into the insertion groove 112 of the substrate 110 with epoxy applied to an outer wall of the magnetic core 122, and fixed by bringing the applied epoxy into contact with the outer wall of the insertion groove 112 of the substrate 110.

In addition, the core unit 120 may be composed only of the winding 121, or configured to include both the winding 121 and the magnetic core 122. When the core unit 120 is configured to include both the winding 121 and the magnetic core 122, the core unit 120 may be inserted into the insertion groove 112 of the substrate 110 in the structure in which the winding 121 may be wound around the outer wall of the magnetic core 122.

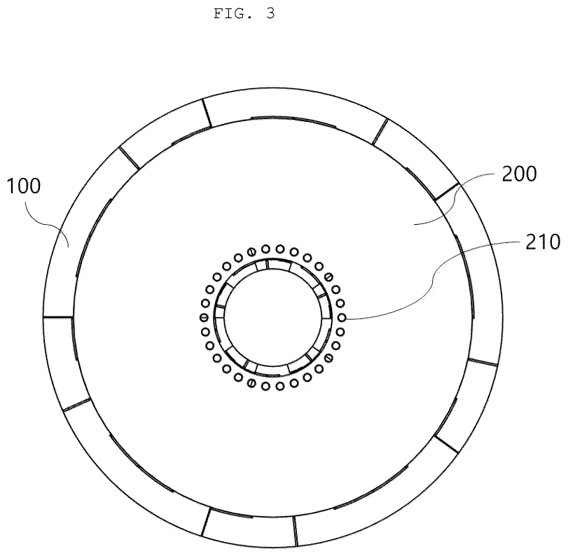

FIG. 3 is a rear view illustrating the PCB stator according to an embodiment of the present disclosure.

Referring to FIG. 3, the PCB stator 100 according to the present disclosure may be attached by brining one side of the PCB stator 100 into contact with the stator back yoke 200.

In this case, the stator back yoke 200 may include at least one lead hole 210 through which a lead wire of the winding 121 embedded in the PCB stator 100 passes. Since the stator back yoke 200 does not rotate, the lead wire of the winding 121 may pass through the lead hole 210 to be connected to the external power supply. That is, the winding 121 embedded in the substrate 110 of the PCB stator 100 may be connected to the external power supply through the lead hole 210 of the stator back yoke 200.

Further, the lead wire of the stator back yoke 200 may be formed on an inner diameter of the stator back yoke 200. Because flux density saturation is less likely to occur on the inner diameter side of the stator back yoke 200 than on the outer diameter side, it is possible to pass the lead wire of the winding 121 through the lead hole 210 without causing any adverse effect.

In addition, the core unit 120, which is configured to include at least one of the winding 121 and the magnetic core 122 inserted into the PCB stator 100, may have epoxy applied to an attachment surface that contacts the stator back yoke 200.

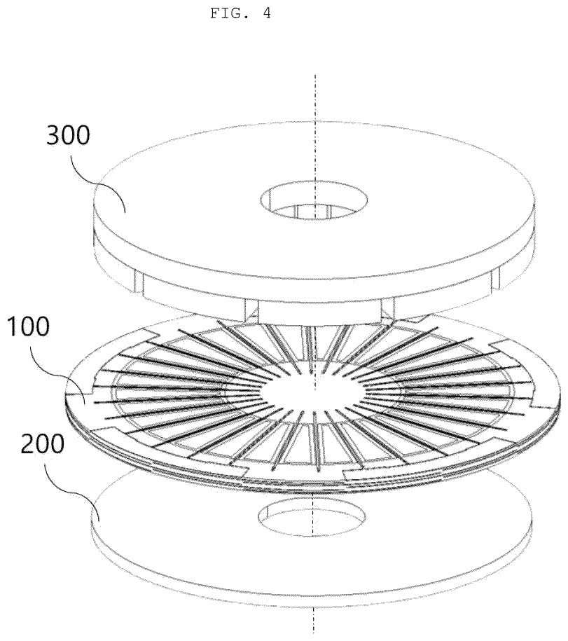

FIG. 4 is an exploded perspective view illustrating the axial flux motor according to an embodiment of the present disclosure.

Referring to FIG. 4, the axial flux motor according to the present disclosure may include the PCB stator 100, the stator back yoke 200, and the rotor 300. Here, the axial flux motor is configured as a single rotor-single stator type, a dual rotor-single stator type, etc., and it is a well-known technology that the number of stators and rotors may be changed depending on the embodiment. It is apparent that the axial flux motor of the present disclosure may also be configured as a dual-rotor single-stator type by forming the stator back yoke 200 as part of the rotor. However, since the axial flux motor according to the present disclosure includes a configuration for increasing efficiency in the single rotor-single stator type, the single rotor-single stator type is described as an example.

The PCB stator 100 may include the substrate 110 and the core unit 120. The substrate 110 has the annular shape, and may be formed with the plurality of conductor patterns 111 and the plurality of insertion grooves 112. The plurality of conductor patterns 111 formed on the substrate 110 may be spaced apart from each other by a predetermined interval in the circumferential direction of the substrate 110. The insertion grooves 112 may be formed between each of the conductor patterns 111. The plurality of conductor patterns 111 formed on the substrate 110 may be arranged side by side along a circumferential direction of the substrate 110 in the linear form extending from the outer peripheral surface of the substrate 110 toward its central axis. The substrate 110 may be electrically connected to the external power supply to generate flux through the plurality of conductor patterns 111, thereby functioning as the stator of the axial flux motor.

The core unit 120 may be inserted into the insertion groove 112 formed on the substrate 110. That is, the core unit 120 may be inserted between the respective conductor patterns 111 of the substrate 110. The core unit 120 may be configured to include at least one of the winding 121 and the magnetic core 122, similar to a slot-type tooth. However, the core unit 120 according to the present disclosure is inserted into the substrate 110 where the flux is formed by the conductor pattern 111, and may be composed of only the magnetic core 122 without including the winding 121. The core unit 120 inserted into the insertion groove 112 of the substrate 110 may be applied with the independent power supply different from the power supply supplied to the substrate 110.

In addition, when the core unit 120 is composed of only the magnetic core 122 without the winding 121, the core unit 120 may be inserted into the insertion groove 112 of the substrate 110 with the epoxy applied to the outer wall of the magnetic core 122, and fixed by bringing the applied epoxy into contact with the outer wall of the insertion groove 112 of the substrate 110.

In addition, the core unit 120 may be composed only of the winding 121, or configured to include both the winding 121 and the magnetic core 122. When the core unit 120 is configured to include both the winding 121 and the magnetic core 122, the core unit 120 may be inserted into the insertion groove 112 of the substrate 110 in the structure in which the winding 121 may be wound around the outer wall of the magnetic core 122.

The stator back yoke 200 may be attached to one side of the PCB stator 100. The stator back yoke 200 may include at least one lead hole 210 through which the lead wire of the winding 121 embedded in the PCB stator 100 passes. Since the stator back yoke 200 does not rotate, the lead wire of the winding 121 may pass through the lead hole 210 to be connected to the external power supply. That is, the winding 121 embedded in the substrate 110 of the PCB stator 100 may be connected to the external power supply through the lead hole 210 of the stator back yoke 200.

Further, the lead wire of the stator back yoke 200 may be formed on the inner diameter of the stator back yoke 200. Because the flux density saturation is less likely to occur on the inner diameter side of the stator back yoke 200 than on the outer diameter side, it is possible to pass the lead wire of the winding 121 through the lead hole 210 without causing any adverse effect.

The rotor 300 includes a plurality of permanent magnets and is positioned on the other side (a surface opposite one side attached to the stator back yoke 200) of the PCB stator 100, so the rotor 300 may rotate by the flux generated by the PCB stator 100.

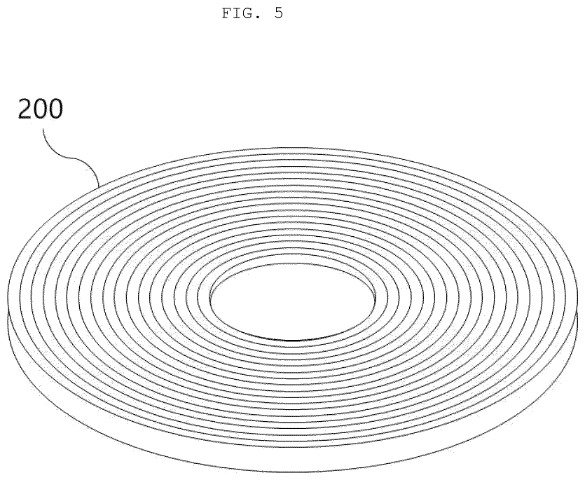

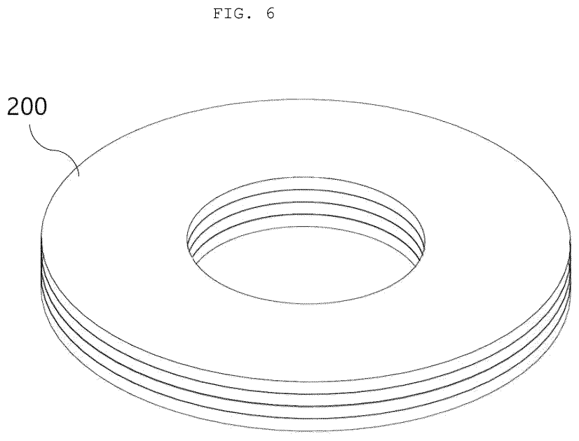

FIGS. 5 and 6 are cross-sectional perspective views illustrating the stator back yoke of the axial flux motor according to an embodiment of the present disclosure. The stator back yoke 200 of the axial flux motor according to the present disclosure may be formed of a soft magnetic material including at least one of a silicon steel sheet, a laminated magnetic core, ferrite, an amorphous metal, and a soft magnetic composite (SMC).

Referring to FIG. 5, the stator back yoke 200 of the axial flux motor according to the present disclosure may include a rolled core formed by rolling an electrical steel sheet of a soft magnetic material. The stator back yoke 200 is formed as the rolled core, thereby reducing eddy current loss.

Referring to FIG. 6, the stator back yoke 200 of the axial flux motor according to the present disclosure may include a structure in which at least one electrical steel sheet of the soft magnetic material is laminated.

In addition, the stator back yoke 200 may include at least one lead hole 210 through which the lead wire of the winding 121 embedded in the PCB stator 100 passes.

According to the present disclosure, by embedding the core unit in the PCB stator, it is possible to improve the counter electromotive force.

In addition, according to the present disclosure, by including the winding or magnetic core in the core unit, it is possible to improve the flux generation efficiency.

Further, according to the present disclosure, by using the independent power supplies for the embedded core unit and the PCB substrate, respectively, it is possible to more increase the efficiency.

Further, according to the present disclosure, by reducing the thickness of the motor to increase the thickness of the permanent magnet, it is possible to improve the performance.

Further, according to the present disclosure, by reducing the thickness of the motor to increase the number of layers of the stator, it is possible to improve the performance.

Further, according to the present disclosure, by removing the single-sided permanent magnet, it is possible to reduce the cost of permanent magnet.

Further, according to the present disclosure, it is possible to reduce the magnetic saturation of the stator back yoke and the rotor back yoke.

Further, according to the present disclosure, by forming the stator back yoke with the rolled core, it is possible to reduce the eddy current loss.

Although preferred embodiments of the present disclosure have been described above, the embodiments disclosed in the present disclosure are only for explaining, not limiting, the technical spirit of the present disclosure. Accordingly, the technical spirit of the present disclosure includes not only each disclosed embodiment, but also a combination of the disclosed embodiments, and further, the scope of the technical spirit of the present disclosure is not limited by these embodiments. In addition, many modifications and alterations of the present disclosure may be made by those skilled in the art to which the present disclosure pertains without departing from the spirit and scope of the accompanying claims. In addition, it is to be considered that all of these modifications and alterations fall within the scope of the present disclosure.

What is claimed is:

1. A printed circuit board (PCB) stator for an axial flux motor, comprising:
a substrate that has an annular shape, and has a plurality of conductor patterns and a plurality of insertion grooves formed thereon; and
a core unit that is inserted into the insertion groove,
wherein the plurality of conductor patterns are formed to be spaced apart from each other at a predetermined interval in a circumferential direction of the substrate, and
the insertion groove is formed between the respective conductor patterns.

2. The PCB stator of claim 1, wherein the core unit includes at least one of a winding and a magnetic core.

3. The PCB stator of claim 2, wherein the winding is applied with an independent power supply different from a power supply applied to the substrate.

4. The PCB stator of claim 2, wherein the core unit includes the magnetic core, and is inserted into the substrate with epoxy applied to an outer wall of the magnetic core, and fixed by bringing the epoxy into contact with the outer wall of the insertion groove of the substrate.

5. The PCB stator of claim 2, wherein the core unit includes a winding and a magnetic core, and the winding is wound around an outer wall of the magnetic core and inserted into the substrate.

6. An axial flux motor, comprising:
the PCB stator of claim 1;
a stator back yoke that is attached to one side of the PCB stator; and
a rotor that includes a plurality of permanent magnets, and is positioned on the other side of the PCB stator to rotate by flux generated by the PCB stator.

7. The axial flux motor of claim 6, wherein the stator back yoke includes at least one lead hole through which a lead wire of a winding inserted into the PCB stator passes.

8. The axial flux motor of claim 6, wherein the stator back yoke includes a soft magnetic material.

9. The axial flux motor of claim 8, wherein the soft magnetic material includes at least one of a silicon steel sheet, a laminated magnetic core, ferrite, an amorphous metal, and a soft magnetic composite (SMC).

10. The axial flux motor of claim 9, wherein the stator back yoke includes a rolled core formed by rolling an electrical steel sheet of a soft magnetic material.

11. The axial flux motor of claim 9, wherein the stator back yoke has a structure in which at least one electrical steel sheet of a soft magnetic material is laminated.
